(19) United States
(12) Patent Application Publication
(10) Pub. No.: US 2007/0176010 A1
(43) Pub. Date: Aug. 2, 2007

(54) System for heating liquids

(75) Inventors: Bruce B. Figi, Rockford, IL (US); Jamie W. Speldrich, Freeport, IL (US)

Correspondence Address: Kris T. Fredrick;Honeywell International Inc., 101 Columbia Rd., P.O. Box 2245, Morristown, NJ, 07962, US

(73) Assignee: Honeywell International Inc.

(21) Appl. No.: 11/327,915

(22) Filed: Jan. 6, 2006

(51) Int. Cl. B60H 1/00

(52) U.S. Cl. 237/2 A

(57) ABSTRACT

A system and method for heating a fluid include a base and a cover, and a flexible heating element maintained between the base and the cover. A wall plate can be provided to which the flexible heating element is connected to create a sealed fluidic flow path encased between the base and the cover, which provides a geometry that creates at least one air pocket for thermal isolation. A fluid can then flow through the fluidic flow path in order to be heated by the flexible heating element, thereby permitting the fluid to be heated to a desired temperature within a particular timeframe. The flexible heater can be formed from, for example, copper. The fluid is mixed in the fluidic flow path to ensure a uniform temperature of the liquid at an exit of the fluidic flow path.

### TECHNICAL FIELD

Embodiments are generally related to sensor systems and methods. Embodiments are also related to devices for heating liquids. Additionally, embodiments are related to flow sensor devices.

### BACKGROUND

Flow sensors are utilized in a variety of fluid-sensing applications for detecting the quality of fluids, including gas and liquid. Thermal sensors of such fluids, which detect the fluid flow or property of fluid, can be implemented, for example, as sensors on silicon in microstructure form. For convenience sake, and without limitation, the term “flow sensor” can be utilized generically to refer to such thermal sensors. The reader will appreciate that such sensors may be also utilized to measure primary properties such as temperature, thermal conductivity, specific heat and other properties; and that the flows may be generated through forced or natural convection.

Generally, a thermal-type flow sensor typically comprises a substrate that includes a heating element and a proximate heat-receiving element or two. If two such sensing elements are used, they are preferably positioned at upstream and downstream sides of the heating element relative to the direction of the fluid (liquid or gas) flow to be measured. When fluid flows along the substrate, it is heated by the heating element at the upstream side and the heat is then transferred non-symmetrically to the heat-receiving elements on either side of the heating element. Since the level of non-symmetry depends on the rate of gas flow, and that non-symmetry can be sensed electronically, such a flow sensor can be used to determine the rate and the cumulative amount of the fluid flow.

Such flow sensors generally face potential degradation problems when exposed to harsh (contaminated, dirty, condensing, etc.) fluids, including gases or liquids that can “stress” the sensor via corrosion, radioactive or bacterial contamination, overheating, or freeze-ups. The sensitive measurement of the flow, or pressure (differential or absolute) of “harsh” gases or liquids that can stress corrode, freeze-up, or overheat the sensing elements is a challenge that is either unmet or met at great expense.

Among the solutions proposed previously are passivation with the associated desensitization of the sensor, heaters to avoid condensation or freeze-ups (or coolers to prevent overheating) at the expense of sensor signal degradation, cost increase and possible fluid degradation, or filters to remove objectionable particulate matter. Frequent cleaning or replacement of the sensors is an additional, but costly, solution. Sensitive, membrane-based differential pressure sensors can be protected against contamination because no flow is involved, but they are much less sensitive and much more expensive than thermal microsensors, in addition to not being overpressure proof.

The use of heaters seems to be advantageous when utilized in the context of such flow sensors. There is a general need to heat flowing liquid to a desired temperature within a given timeframe. To date, however, an efficient system and/or method for heating fluid or liquid in the context of such flow sensors has not been effectively developed. It is believed that the system and methodology disclosed herein offer a new and heretofore undeveloped solutions for this unmet need.

### BRIEF SUMMARY

The following summary is provided to facilitate an understanding of some of the innovative features unique to the embodiments and is not intended to be a full description. A full appreciation of the various aspects of the embodiments disclosed can be gained by taking the entire specification, claims, drawings, and abstract as a whole.

It is, therefore, one aspect of the present invention to provide for a system and method for heating a liquid.

It is another aspect of the present invention to provide for an improved system and method for heating a liquid within a given timeframe. The aforementioned aspects of the invention and other objectives and advantages can now be achieved as described herein. A system and methodology for heating a fluid are disclosed. In general, a base and a cover can be provided. A flexible heating element can be maintained between the base and the cover. Additionally, a wall plate can be provided to which the flexible heating element is connected to create a sealed fluidic flow path encased between the base and the cover, which provides a geometry that creates at least one air pocket for thermal isolation.

A fluid can then flow through the fluidic flow path in order to be heated by the flexible heating element, thereby permitting the fluid to be heated to a desired temperature within a particular timeframe. The flexible heater can be formed from, for example, copper. The fluid is mixed in the fluidic flow path to ensure a uniform temperature of the liquid at an exit of the fluidic flow path. The base and the cover can be formed from, for example, a polyimide film such as Kapton®. Such a polyimide film remains stable preferably in a range of temperatures from approximately −269° C. to 400° C.

Such a system and method solves the need to heat flowing fluid or liquid to a desired temperature within a given timeframe. Such a system and method thus provides heat to a fluid or liquid encased in a fluidic path. The heating element provides heat through a membrane. A thin wall geometry is used in conjunction with an air barrier to ensure the efficient use of the heat generated by the heating element.

The system describe herein can be composed of plastic components and a flexible heater. The flexible heater or flexible heating element can be formed from copper in association with the base and the cover to hold the various layers together. The flexible heating element can be adhered to the thin wall plate and the plastic components combined to created the sealed flow path and provide the geometry that creates the air pockets for thermal isolations.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the principles of the disclosed embodiments.

FIG. 1 illustrates a top view of a system for heating a liquid, in accordance with a preferred embodiment; and

FIG. 2 illustrates a perspective view of the system depicted in FIG. 1, in accordance with a preferred embodiment.

### DETAILED DESCRIPTION

The particular values and configurations discussed in these non-limiting examples can be varied and are cited merely to illustrate at least one embodiment and are not intended to limit the scope of the invention.

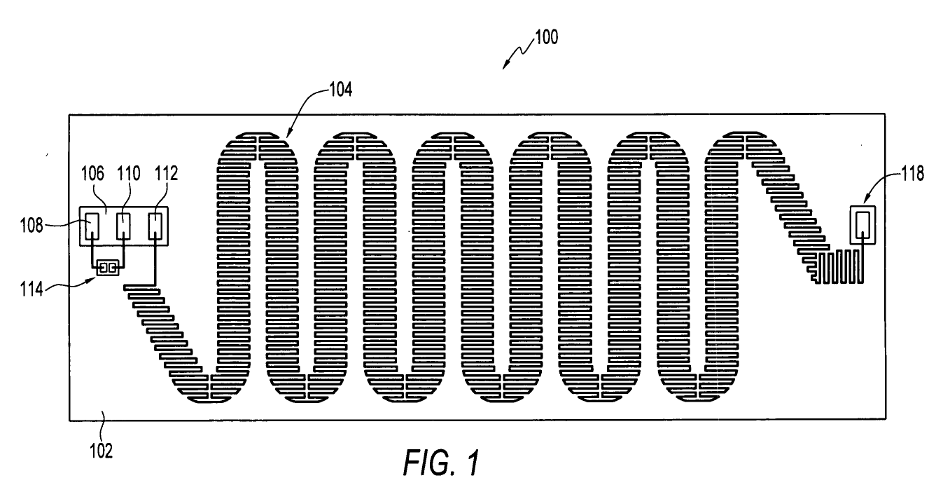

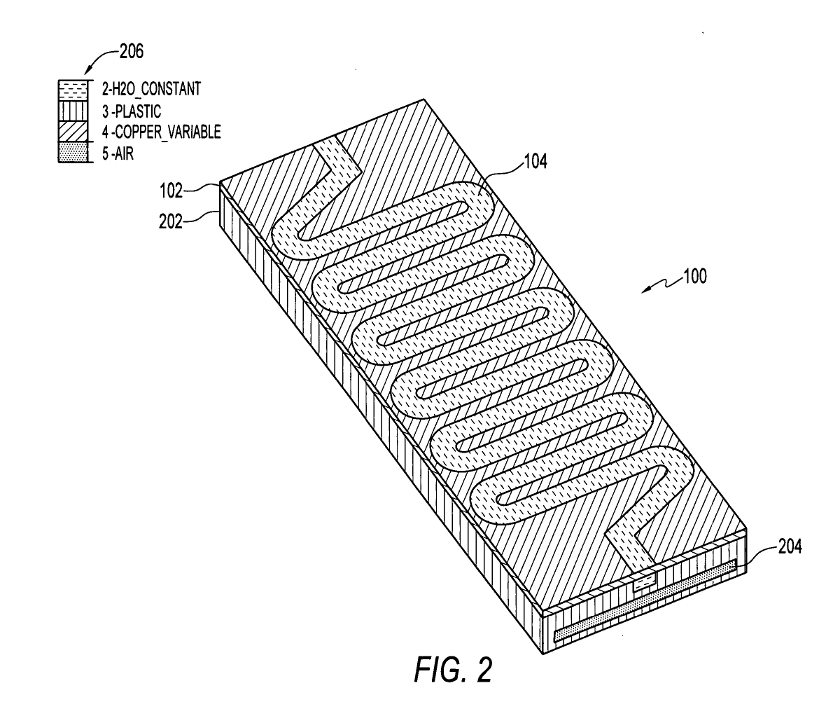

FIG. 1 illustrates a top view of a system 100 for heating a liquid, in accordance with a preferred embodiment. FIG. 2 illustrates a perspective view of the system 100 depicted in FIG. 1, in accordance with a preferred embodiment. Note that in FIGS. 1-2, identical or similar parts or elements are generally indicated by identical reference numerals. System 100 generally provides heat to a liquid encased in a fluidic path. A flexible heating element 104 can be provided, which provides heat for heating a liquid or fluid. The flexible heating element 104 can be maintained between a base 202 and a cover 102. Heating element 104 can function based on an operating wattage of for example, approximately 70 Watts. It can be appreciated, however, that other operating wattages can be implemented, depending upon design considerations. 70 Watts is only a suggested operating wattage for heating element 104 and does not constitute a limiting feature of the embodiments.

Note that the heating element 104 is illustrated in FIGS. 1-2 as configured in a serpentine pattern. It can be appreciated, however, that such a serpentine pattern is provided for illustrative and exemplary purposes only and that a number of other pattern and shapes for heating element 104 can be implemented, depending upon design goals and structural considerations. The serpentine pattern of heating element 104 depicted herein is thus not considered a limiting feature of the disclosed embodiments.

The flexible heating element 104 can be connected to an electrical connector 106 composed of one or more electrical components 108, 110, 112. Note that components 108 and 110 can be connected to another electrical component 114. The flexible heating element 104 can also be connected to an electrical connector 118, depending upon design considerations. Additionally, a wall plate (not shown in FIGS. 1-2) can be provided to which the flexible heating element is connected to create the sealed fluidic flow path encased between the base 202 and the cover 102, which provides a geometry that creates one or more air pockets 204.

A fluid can then flow through the fluidic flow path in order to be heated by the flexible heating element 104, thereby permitting the fluid to be heated to a desired temperature within a particular timeframe. The flexible heater or heating element 104 can be formed from, for example, copper. Additionally, the fluid can be mixed in the fluidic flow path to ensure a uniform temperature of the liquid at an exit of the fluidic flow path. The base 202 and the cover 102 can be formed from, for example, a polyimide film such as Kapton®.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for heating a fluid, comprising:
a base and a cover;
a flexible heating element maintained between said base and said cover; and
a wall plate to which said flexible heating element is connected to create a sealed fluidic flow path encased between said base and said cover to provide a geometry that creates at least one air pocket for thermal isolation, wherein a fluid flows through said fluidic flow path in order to be heated by said flexible heating element, thereby permitting said fluid to be heated to a desired temperature within a particular timeframe.

2. The system of claim 1 wherein said flexible heater comprises copper.

3. The system of claim 1 wherein said fluid is mixed in said fluidic flow path to ensure a uniform temperature of said liquid at an exit of said fluidic flow path.

4. The system of claim 1 wherein said geometry that creates said at least one air pocket for thermal isolation comprises a wall geometry associated with said wall plate in conjunction with an air barrier to ensure an efficient use of heat generated by said flexible heating element.

5. The system of claim 1 wherein said base and said cover comprise a polyimide film.

6. The system of claim 5 wherein said polyimide film remains stable in a range of temperatures from approximately −269° C. to 400° C.

7. The system of claim 1 wherein said wall plate comprises plastic.

8. The system of claim 1 wherein said flexible heating element comprises an operating wattage of approximately 70 Watts.

9. The system of claim 1 wherein said flexible heating element comprises a resistance element.

10. A system for heating a fluid, comprising:
a base and a cover, wherein said base and said cover comprise a polyimide film;
a flexible heating element maintained between said base and said cover; and
a wall plate to which said flexible heater is connected to create a sealed fluidic flow path encased between said base and said cover to provide a geometry that creates at least one air pocket for thermal isolation, wherein a fluid flows through said fluidic flow path in order to be heated by said flexible heating element, thereby permitting said fluid to be heated to a desired temperature within a particular timeframe and wherein said fluid is mixed in said fluidic flow path to ensure a uniform temperature of said liquid at an exit of said fluidic flow path.

11. The system of claim 10 wherein said flexible heater comprises copper.

12. The system of claim 10 wherein said geometry that creates said at least one air pocket for thermal isolation comprises a wall geometry associated with said wall plate in conjunction with an air barrier to ensure an efficient use of heat generated by said flexible heating element.

13. A method for heating a fluid, comprising:
providing a base and a cover;
maintaining a flexible heating element maintained between said base and said cover; and
connecting a wall plate to said flexible heater to create a sealed fluidic flow path encased between said base and said cover to provide a geometry that creates at least one air pocket for thermal isolation, wherein a fluid flows through said fluidic flow path in order to be heated by said flexible heating element, thereby permitting said fluid to be heated to a desired temperature within a particular timeframe.

14. The method of claim 13 further comprising configuring said flexible heater from copper.

15. The method of claim 13 further comprising mixing said fluid in said fluidic flow path to ensure a uniform temperature of said liquid at an exit of said fluidic flow path.

16. The method of claim 13 wherein configuring said geometry that creates said at least one air pocket for thermal isolation to comprise a wall geometry associated with said wall plate in conjunction with an air barrier to ensure an efficient use of heat generated by said flexible heating element.

17. The method of claim 13 wherein said base and said cover comprise a polyimide film.

18. The method of claim 17 wherein said polyimide film remains stable in a range of temperatures from approximately −269° C. to 400° C.

19. The method of claim 13 further comprising configuring said wall plate from plastic.

20. The method of claim 13 further comprising forming said flexible heating element from a resistance element.
